(19) United States
(12) Patent Application Publication
(10) Pub. No.: US 2023/0420639 A1
(43) Pub. Date: Dec. 28, 2023

(54) Positive Electrode Plate, Preparation Method therefore and Lithium-Ion Secondary Battery

(71) Applicant: JIANGSU ZENERGY BATTERY TECHNOLOGIES CO., LTD., Changshu Suzhou City, Jiangsu (CN)

(72) Inventors: Yanlin HAN, Dongguan, Guangdong (CN); Zhexun YU, Dongguan, Guangdong (CN); Wujun ZOU, Dongguan, Guangdong (CN); Lingming KONG, Dongguan, Guangdong (CN)

(21) Appl. No.: 18/039,475

(22) PCT Filed: Oct. 12, 2021
(86) PCT No.: PCT/CN2021/123201

§ 371 Date: May 30, 2023

(30) Foreign Application Priority Data
Mar. 5, 2021 (CN) 202110254395.8

(51) Int. Cl. H01M 4/131; H01M 4/1391; H01M 4/505; H01M 4/525; H01M 4/04; H01M 10/0525; H01M 10/0587; H01M 4/133; H01M 4/587

(52) U.S. Cl. CPC H01M 4/131; H01M 4/1391; H01M 4/505; H01M 4/525; H01M 4/0404; H01M 10/0525; H01M 10/0587; H01M 4/133; H01M 4/587; H01M 2004/028

(57) ABSTRACT

Disclosed are a positive electrode plate, a preparation method therefore and a lithium-ion secondary battery, relating to the technical field of batteries. The positive electrode plate includes a positive electrode current collector and a positive electrode coating layer that is coated on the positive electrode current collector and contains a positive electrode active substance; the positive electrode plate satisfies 0.07<a\hat{ }3*10*β/γ<0.14, a represents the compaction density of the positive electrode coating layer, β represents the surface density of the positive electrode coating layer, and γ represents the thickness of the positive electrode current collector. While the positive electrode plate satisfies the above formula, the compaction density, the surface density and the current collector thickness of the positive electrode plate may be reasonably configured, such that it satisfies the requirements of the formula 0.07<a\hat{ }3*10*β/γ<0.14, and thus the lithium-ion secondary battery prepared by it has a long service life and excellent DCR performance.

### CROSS-REFERENCE TO RELATED APPLICATION

The present disclosure claims priority to Chinese patent application 202110254395.8, filed to the China National Intellectual Property on Mar. 5, 2021 and entitled “Positive Electrode Plate, Preparation Method therefore and Lithium-Ion Secondary Battery”, the disclosure of which is hereby incorporated by reference in its entirety.

### TECHNICAL FIELD

The present disclosure relates to the technical field of batteries, in particular to a positive electrode plate, a preparation method therefor and a lithium-ion secondary battery.

### BACKGROUND

With the increasing global exhaust emission requirements, new energy vehicles become a new direction for the development of the automotive industry. Lithium-ion batteries, as a rechargeable battery with high energy density, no pollution, and long service life, are widely used in the new energy vehicles. As the power source of the new energy vehicle, the lithium-ion battery must have guaranteed power output, and the direct current resistance (DCR) of the lithium-ion battery is one of the important limiting factors for the power output of the lithium-ion battery.

In view of this, providing a lithium-ion battery that may maintain a longer service life and continuously provide high-power output power is a necessary condition for promoting the development of the new energy vehicle industry.

### SUMMARY

A first purpose of the present disclosure is to provide a positive electrode plate, and it may control the compaction density and surface density of its coating layer, and the thickness of a positive electrode current collector, so that a lithium-ion secondary battery prepared by the positive electrode plate has the characteristics of long service life and excellent DCR performance.

A second purpose of the present disclosure is to provide a preparation method for a positive electrode plate, and it may prepare the above positive electrode plate by a simple and convenient preparation process.

A third purpose of the present disclosure is to provide a lithium-ion secondary battery, and it includes the above positive electrode plate, thus it has the advantages of long service life and lower DCR.

Embodiments of the present disclosure may be achieved as follows.

In a first aspect, the present disclosure provides a positive electrode plate, including:
a positive electrode current collector and a positive electrode coating layer that is coated on the positive electrode current collector and contains a positive electrode active substance; the positive electrode plate satisfies a formula: 0.07<a\hat{ }3*10*β/γ<0.14, herein a represents the compaction density of the positive electrode coating layer, and the unit is g/cm³; β represents the surface density of the positive electrode coating layer, and the unit is g/cm²; and γ represents the thickness of the positive electrode current collector, and the unit is μm.

In an optional implementation mode, the positive electrode plate satisfies a formula: 0.1<a\hat{ }3*10*β/γ<0.125.

In an optional implementation mode, the value range of the compaction density of the positive electrode coating layer is 2.6≤α≤3.2;
the value range of the surface density of the positive electrode coating layer is 0.007≤β≤0.0085; and
the value range of the thickness of the positive electrode current collector is 10≤γ≤25.

In an optional implementation mode, the value range of the compaction density of the positive electrode coating layer is 2.75≤α≤3.1;
the value range of the surface density of the positive electrode coating layer is 0.007≤β≤0.0075; and
the value range of the thickness of the positive electrode current collector is 16≤γ≤20.

In an optional implementation mode, the positive electrode active substance is any one of lithium cobalt oxide, lithium nickel oxide, lithium manganese oxide, lithium nickel manganese oxide, lithium nickel cobalt manganese oxide, lithium nickel cobalt aluminum oxide, and olivine structure containing lithium phosphate.

In an optional implementation mode, the positive electrode current collector is any one of aluminum foil, carbon coated aluminum foil, and nickel mesh.

In a second aspect, the present disclosure provides a preparation method for the positive electrode plate in any one of the aforementioned embodiments, including:
mixing the positive electrode active substance with an auxiliary agent to prepare slurry; and
applying the slurry evenly on the positive electrode current collector, drying and cold-pressing to obtain the positive electrode plate.

In a third aspect, the present disclosure provides a lithium-ion secondary battery, including: the positive electrode plate in any one of the aforementioned embodiments, as well as a negative electrode plate, an isolation film and an electrolyte, herein the positive electrode plate, the isolation film, and the negative electrode plate are used to stack and wind successively to obtain an electrical core, and the electrolyte is used to inject into the dry electrical core to obtain the lithium-ion secondary battery.

In an optional implementation mode, the negative electrode plate includes a negative electrode current collector and a negative electrode coating layer that is coated on the negative electrode current collector and contains a negative electrode active substance; herein, the compaction density of the negative electrode coating layer is 1.35 g/cm³; the surface density of the negative electrode coating layer is 0.0058 g/cm²; and the thickness of the negative electrode current collector is 8 μm.

In an optional implementation mode, the negative electrode active substance is any one of graphite, soft carbon, hard carbon, mesophase carbon microsphere, and silicon-based material.

The embodiments of the present disclosure at least include the following advantages or beneficial effects.

The embodiment of the present disclosure provides a positive electrode plate, and it includes a positive electrode current collector and a positive electrode coating layer that is coated on the positive electrode current collector and contains a positive electrode active substance; the positive electrode plate satisfies a formula: 0.07<a\hat{ }3*10*β/γ<0.14, herein a represents the compaction density of the positive electrode coating layer, and the unit is g/cm³; β represents the surface density of the positive electrode coating layer, and the unit is g/cm²; and γ represents the thickness of the positive electrode current collector, and the unit is μm. While the positive electrode plate satisfies the above formula, the lithium-ion secondary battery prepared by it may have the long service life and excellent DCR performance.

The embodiment of the present disclosure further provides a preparation method for a positive electrode plate, and it may prepare the above positive electrode plate by the simple and convenient operation.

The embodiment of the present disclosure provides a lithium-ion secondary battery, including: a positive electrode plate, a negative electrode plate, an isolation film and an electrolyte; the positive electrode plate, the isolation film, and the negative electrode plate are used to stack and wind successively to obtain an electrical core, and the electrolyte is used to inject into the dry electrical core to obtain the lithium-ion secondary battery. The positive electrode plate of this lithium-ion secondary battery may be reasonably matched with the compaction density and surface density of the positive electrode plate and the thickness of the selected current collector, so the lithium-ion secondary battery has the long service life and excellent DCR performance.

### DETAILED DESCRIPTION OF THE EMBODIMENTS

In order to make purposes, technical schemes and advantages of the embodiments of the present disclosure clearer, the technical schemes in embodiments of the present disclosure are clearly and completely described below. The embodiments, in which specific conditions are not indicated, are performed according to the conventional conditions or the conditions recommended by manufacturers. Reagents or instruments used without specifying the manufacturers are all conventional products that may be obtained by commercial purchase.

The features and performance of the present disclosure are further described in detail below in combination with the embodiments.

The embodiment of the present disclosure provides a positive electrode plate, and it is used to manufacture a lithium-ion secondary battery. Herein the positive electrode plate includes a positive electrode current collector and a positive electrode coating layer that is coated on the positive electrode current collector and contains a positive electrode active substance; the positive electrode plate satisfies a formula: herein a represents the compaction density of the positive electrode coating layer, and the unit is g/cm³; β represents the surface density of the positive electrode coating layer, and the unit is g/cm²; and γ represents the thickness of the positive electrode current collector, and the unit is μm.

Specifically, the compaction density of the positive electrode coating layer, the surface density of the positive electrode coating layer, and the thickness of the positive electrode current collector of the positive electrode plate all have different effects on the DCR performance of the battery. However, the effects have certain limitations and mutual influence, only if the formula: 0.07<a\hat{ }3*10*β/γ<0.14 is satisfied, it may have both the longer service life and the excellent DCR performance. Therefore, in the actual production and manufacturing processes, the compaction density of the positive electrode coating layer, the surface density of the positive electrode coating layer, and the current collector thickness of the lithium-ion secondary battery may also be designed according to the above formula, so that the designed battery may have the good service life and excellent DCR performance, while a large number of DOE experiments may also be avoided, the battery development time and cost are saved.

As a preferred scheme, while it satisfies a formula: 0.1<a\hat{ }3*10*β/γ<0.125, it has the longer service life and more excellent DCR performance. According to this formula, the compaction density of the positive electrode coating layer, the surface density of the positive electrode coating layer, and the current collector thickness of the lithium-ion secondary battery may be designed, to guarantee that it has the above excellent electrochemical performance.

More specifically, in the embodiment of the present disclosure, a is the compaction density of the positive electrode coating layer of the lithium-ion secondary battery. The value range of the compaction density for the positive electrode coating layer is 2.6≤α≤3.2, and the preferred value range is 2.75≤α≤3.1. The basis for its design is that while the lithium-ion battery is discharged, lithium ions are detached from a negative electrode material and are embedded in a positive electrode material, and the process of the lithium ions embedding from the positive electrode is closely related to the compaction density of the positive electrode coating layer. On the one hand, the low compaction density increases the liquid absorption ability of the positive electrode, and ion channels are increased, it is helpful to improve ion transmission; however, if the compaction density is too low, the ion transmission distance is increased, the particle spacing is increased, and the electronic conductivity is decreased, it may increase the internal resistance in turn. On the other hand, the high compaction density, close particle contact, good electronic conductivity, and short ion transmission channels are beneficial for reducing the internal resistance; however, the excessively high compaction density may cause adverse factors such as particle breakage, poor positive electrode liquid absorption, and blockage of the ion transmission channels. Therefore, while the compaction density of the positive electrode coating layer of the lithium-ion secondary battery satisfies the above selection adjustment and the above formula, it may effectively guarantee that the lithium-ion secondary battery has both the longer service life and the excellent DCR performance.

More specifically, in the embodiment of the present disclosure, 13 is the surface density of the positive electrode coating layer of the lithium-ion battery. The value range of the surface density of the positive electrode coating layer is 0.007≤β≤0.0085, and the preferred value range is 0.007≤β≤0.0075. The basis for its design is that while the surface density of the electrode plate is decreased, the porosity of the material is increased, the liquid absorption capacity of the electrode plate is increased, and the contact resistance is decreased; the surface density is smaller, the thickness of the electrode plate is smaller, and the ion transmission distance is also shortened; at the same time, the surface density is smaller, a solid electrolyte interface (SEI) film formed during formation is thin and stable, and the migration resistance of the lithium ions in the SEI film may also be reduced. However, if the surface density is too low, it may affect the capacity of the lithium-ion battery, and may be limited by a coating process. Therefore, while the value range of β is controlled between 0.0070˜0.0085, it may effectively guarantee that the lithium-ion secondary battery has both the longer service life and excellent DCR performance.

More specifically, γ is the thickness of the positive electrode current collector of the lithium-ion battery. The value range of the thickness of the positive electrode current collector is 10≤γ≤25, and the preferred value range is 16≤γ≤20. The basis for its design is that the current collector may play a role in electronic transmission. On the one hand, if the thickness of the current collector is too low, it may increase the electronic internal resistance of the lithium-ion battery, and is also limited by the production process of the current collector and the coating process of the lithium-ion battery. On the other hand, although the excessively high thickness of the current collector reduces the electronic internal resistance of the lithium-ion battery, the thickness of a lithium-ion battery coil core is increased correspondingly, the margin of lithium-ion battery clusters is increased, and the capacity of the lithium-ion battery is affected. Therefore, while the value range of γ is controlled within the above range and satisfies the above required formula, it may also effectively guarantee that the lithium-ion secondary battery has both the longer service life and excellent DCR performance.

Therefore, in conclusion, while the compaction density, the surface density, and the selected current collector thickness of the positive electrode plate satisfy the above requirements, the lithium-ion battery may have both the long service life and excellent DCR performance.

The embodiment of the present disclosure further provides a preparation method for a positive electrode plate, and it includes: mixing the positive electrode active substance with an auxiliary agent to prepare slurry; and applying the slurry evenly on the positive electrode current collector, drying and cold-pressing to obtain the positive electrode plate. This method may quickly and conveniently prepare the positive electrode plate satisfying the formula: 0.07<a\hat{ }3*10*β/γ<0.14, thus it is guaranteed that the lithium-ion secondary battery prepared by it has the lower DCR value and longer service life.

It should be noted that the auxiliary agent is usually selected as a conductive agent, a binder, and other substances necessary for its formation. Compared to existing technologies, the selection and ratio of the auxiliary agent are not improved, and may not be repeatedly described here. The active position of the positive electrode and the type of the current collector and the like may also be determined according to conventional choices, for example, the positive electrode active substance is any one of lithium cobalt oxide, lithium nickel oxide, lithium manganese oxide, lithium nickel manganese oxide, lithium nickel cobalt manganese oxide, lithium nickel cobalt aluminum oxide, and olivine structure containing lithium phosphate. The positive electrode current collector may also be selected as any one of aluminum foil, carbon coated aluminum foil, and nickel mesh. Regardless of its component selection and dosage ratio, while it satisfies the above formula of 0.07<a\hat{ }3*10*β/γ<0.14 in the preparation process, it may be guaranteed that the lithium-ion secondary battery prepared by it has the longer service life and relatively excellent DCR performance.

The embodiment of the present disclosure further provides a lithium-ion secondary battery, and it includes: a positive electrode plate, a negative electrode plate, an isolation film and an electrolyte; and the positive electrode plate, the isolation film, and the negative electrode plate are used to stack and wind successively to obtain an electrical core, and the electrolyte is used to inject into the dry electrical core to obtain the lithium-ion secondary battery. The lithium-ion secondary battery has the lower DCR value and longer service life because it is prepared by the above positive electrode plate.

It should also be noted that in this embodiment, the negative electrode plate is also coated with a negative electrode active substance, and the negative electrode plate also includes components such as the electrode active substance, the conductive agent, the binder, a dispersant, and a current collector. The selection of each component is the same as the existing technologies, for example, the negative electrode active substance may be graphite, soft carbon, hard carbon, mesophase carbon microsphere, silicon-based material and the like, and the current collector may be a copper foil and the like.

Meanwhile, in the embodiment of the present disclosure, the compaction density of the negative electrode coating layer is 1.35 g/cm³; the surface density of the negative electrode coating layer is 0.0058 g/cm²; and the thickness of the negative electrode current collector is 8 μm. The compaction density of the negative electrode coating layer, the surface density of the negative electrode coating layer and the thickness of the negative electrode current collector are controlled to the above values, in order to match the positive electrode plate, so the lithium-ion secondary battery with the long service life and excellent DCR performance is prepared by the above positive electrode plate and negative electrode plate. Certainly, in other embodiments of the present disclosure, the types and components of the negative electrode active substance, the conductive agent, the binder, the dispersants, and the current collector may also be selected according to the preparation requirements, so that it satisfies the requirements of the above formula.

In addition, in the embodiments of the present disclosure, the type of the isolation film is not limited, and may be selected according to actual needs, for example, the isolation film may be selected as a polyethylene film, a polypropylene film, a polyvinylidene fluoride film, and non-woven fabric and other materials. The electrolyte includes a lithium salt solute and a solvent. Herein, the types of the lithium salt and the solvent are not subject to specific restrictions, and may be selected according to actual needs. For example, the lithium salt may be selected as LiPF₆, LiTFSI, LiBF4 and the like, and it is not limited in this embodiment.

The embodiment of the present disclosure further provides a preparation method for the lithium-ion secondary battery mentioned above, and it specifically includes the following steps:
S1: Stacking and winding the positive electrode plate, the isolation film and the negative electrode plate to obtain an electrical core.

Herein, the step S1 specifically includes preparation of the negative electrode plate, preparation of the positive electrode plate, preparation of the isolation films, and preparation of the battery cell, specifically including:
S11: the preparation process of the positive electrode plate includes: mixing the positive electrode active substance, the conductive agent, and the binder in a certain mass ratio, adding N-methyl pyrrolidine (NMP), and stirring to form uniformly mixed and stable first slurry; applying the first slurry evenly on the positive electrode current collector, drying and cold-pressing to obtain the positive electrode plate, herein, the mass ratio may be selected as a proportion of conventional preparation for an existing lithium-ion secondary battery, and it is not repeatedly described here;
S12: the preparation process of the negative electrode plate includes: after mixing the negative electrode active substance, the conductive agent, the binder, and the dispersant in a certain mass ratio, adding deionized water, and stirring to form uniformly mixed and stable second slurry; applying the second slurry evenly on the negative electrode current collector, drying and cold-pressing to obtain the negative electrode plate, herein the mass ratio may be selected as the proportion of conventional preparation for the existing lithium-ion secondary battery, and it is not repeatedly described here;
S13: the preparation process of the isolation film includes: selecting the polypropylene film as the isolation film; and
S14: the preparation process of the electrical core includes: stacking the above prepared positive electrode plate, isolation film and negative electrode plate, and winding to obtain the battery cell.
S2: Injecting the electrolyte into the dry electrical core, and vacuum-packaging, immobilizing, forming and shaping to obtain the lithium-ion secondary battery.

Herein, the step S2 specifically includes preparation of the electrolyte and preparation process of the battery, and it specifically includes the following steps.
S21: preparation of electrolyte: mixing ethylene carbonate (EC), methyl ethyl carbonate (EMC) and diethyl carbonate (DEC) according to a volume ratio of 1:1:1 to obtain an organic solvent, then dissolving the fully dried lithium salt LiPF₆ in the mixed organic solvent, to prepare an electrolyte with a concentration of 1.2 mol/L; and
S22: preparation of battery: placing the electrical core in an outer packaging housing, injecting the electrolyte after drying, and performing working procedures such as vacuum-packaging, immobilizing, forming and shaping, to obtain the lithium-ion battery.

The above preparation method and process are described in detail below by the specific embodiments.

### Embodiments 1-10

Embodiments 1-10 all provide a lithium-ion secondary battery, and it was prepared by the following method.
S11: preparation of positive electrode plate: mixing a positive electrode active substance NCM111, a conductive agent SP, and a binder PVDF in a certain mass ratio, adding NMP, and stirring to form uniformly mixed and stable first slurry; and applying the first slurry evenly on a positive electrode current collector, drying and cold-pressing to obtain the positive electrode plate that satisfies the requirements of Table 1;
S12: preparation of negative electrode plate: after mixing negative electrode active substance graphite, the conductive agent SP, a binder LA133, and a dispersant CMC according to a certain mass ratio, adding deionized water, and stirring to form uniformly mixed and stable second slurry; and applying the second slurry evenly on a negative electrode current collector, drying and cold-pressing to obtain the negative electrode plate that satisfies the requirements of Table 1;
S13: preparation of isolation film: selecting a polypropylene film as the isolation film;
S14: preparation of battery cell: stacking the above prepared positive electrode plate, isolation film, and negative electrode plate, and winding to obtain the battery cell.
S21: preparation of electrolyte: mixing EC, EMC and DEC according to a volume ratio of 1:1:1 to obtain an organic solvent, and then dissolving the fully dried lithium salt LiPF₆ in the mixed organic solvent, to prepare an electrolyte with a concentration of 1.2 mol/L; and
S21: preparation of battery: placing the battery cell in an outer packaging housing, injecting the electrolyte after drying, and performing working procedures such as vacuum-packaging, immobilizing, forming and shaping, to obtain the lithium-ion battery.

The difference between Embodiments 1-10 was that, as shown in Table 1, the positive electrode plate of Embodiments 1-10 was prepared by using the different compaction densities of the positive electrode coating layer, the different surface densities of the positive electrode coating layer, and the different thicknesses of the positive electrode current collector.

| | Positive electrode plate | | | Negative electrode plate | | | 60 C | |
|---|---|---|---|---|---|---|---|---|
| Embodiment | α(PD) | β(CW) | γ(Al) | PD | CW | Cu | DCR | α\hat{ }3*10*β/γ |
| 1 | 3.00 | 0.0077 | 16 | 1.35 | 0.0058 | 8 | 2.27 | 0.1299 |
| 2 | 3.10 | 0.0077 | 16 | 1.35 | 0.0058 | 8 | 3.14 | 0.1434 |
| 3 | 3.20 | 0.0077 | 16 | 1.35 | 0.0058 | 8 | 3.18 | 0.1577 |
| 4 | 3.00 | 0.0071 | 16 | 1.35 | 0.0058 | 8 | 1.90 | 0.1198 |
| 5 | 2.85 | 0.0075 | 16 | 1.35 | 0.0058 | 8 | 2.04 | 0.1085 |
| 6 | 2.85 | 0.0082 | 16 | 1.35 | 0.0058 | 8 | 2.20 | 0.1186 |
| 7 | 2.75 | 0.0082 | 16 | 1.35 | 0.0058 | 8 | 2.19 | 0.1066 |
| 8 | 3.00 | 0.0077 | 20 | 1.35 | 0.0058 | 8 | 1.94 | 0.1040 |
| 9 | 2.75 | 0.0075 | 20 | 1.35 | 0.0058 | 8 | 2.40 | 0.0780 |
| 10 | 2.60 | 0.0075 | 20 | 1.35 | 0.0058 | 8 | 2.45 | 0.0659 |

### Experimental Example

A DCR test was performed on the lithium-ion secondary battery prepared in Embodiments 1-10, and a testing method included fully charging the lithium-ion battery with a 1 C current at constant current and voltage and 25° C., after standing for 5 min, discharging at 1 C for 30 min, and then discharging at 60 C for 10 s after standing for 5 min. DCR was calculated by a formula of (voltage V1 before discharge at 60 C−voltage V2 after discharge at 60 C)/60 C current, and test results were shown in Table 1. Based on data in Table 1, it may be seen that the designs of the positive electrode plates in Embodiment 2 and Embodiment 3 were unreasonable, and the excessively high compaction density leads to ion diffusion obstruction, and DCR was relatively high. The design of the positive electrode plate in Embodiment 10 was unreasonable, the excessively low compaction density affected the electronic conductivity, and DCR was slightly high. Embodiments 1, 4, 5, 6, 7, 8, and 9 all complied with the requirements of 0.07<a\hat{ }3*10*β/γ<0.14, so it may improve the DCR performance of the lithium-ion secondary battery, especially data in Embodiment 4, 5, 6, 7, and 8 still complied with the requirements of preferred 0.1<a\hat{ }3*10*β/γ<0.125, and it may significantly improve the DCR performance of the lithium-ion secondary battery.

In conclusion, the embodiment of the present disclosure provides a positive electrode plate, a preparation method therefore and a lithium-ion secondary battery. By limiting the compaction density, surface density and selected current collector thickness of the positive electrode plate, the positive electrode plate of the lithium-ion secondary battery satisfies the formula of 0.07<a\hat{ }3*10*β/γ<0.14, thereby the lithium-ion secondary battery has both the long service life and excellent DCR performance.

The above are only the specific implementation modes of the present disclosure, but the scope of protection of the present disclosure is not limited to this. Any changes or replacements that may be easily imagined by technical personnel familiar with the technical field within the technical scope disclosed by the present disclosure should be covered within the scope of protection of the present disclosure.

Therefore, the scope of protection of the present disclosure should be based on the scope of protection of the claims.

What is claimed is:

1. A positive electrode plate, comprising:
a positive electrode current collector and a positive electrode coating layer that is coated on the positive electrode current collector and contains a positive electrode active substance; the positive electrode plate satisfies a formula: 0.07<a\hat{ }3*10*β/γ<0.14, wherein a represents the compaction density of the positive electrode coating layer, and the unit is g/cm³; β represents the surface density of the positive electrode coating layer, and the unit is g/cm²; and γ represents the thickness of the positive electrode current collector, and the unit is μm.

2. The positive electrode plate according to claim 1, wherein:
the positive electrode plate satisfies a formula: 0.1<a\hat{ }3*10*β/γ<0.125.

3. The positive electrode plate according to claim 1, wherein:
the value range of the compaction density of the positive electrode coating layer is 2.6≤α≤3.2;
the value range of the surface density of the positive electrode coating layer is 0.007≤β≤0.0085; and
the value range of the thickness of the positive electrode current collector is 10≤γ≤25.

4. The positive electrode plate according to claim 3, wherein:
the value range of the compaction density of the positive electrode coating layer is 2.75≤α≤3.1;
the value range of the surface density of the positive electrode coating layer is 0.007≤β≤0.0075; and
the value range of the thickness of the positive electrode current collector is 16≤γ≤20.

5. The positive electrode plate according to claim 1, wherein:
the positive electrode active substance is any one of lithium cobalt oxide, lithium nickel oxide, lithium manganese oxide, lithium nickel manganese oxide, lithium nickel cobalt manganese oxide, lithium nickel cobalt aluminum oxide, and olivine structure containing lithium phosphate.

6. The positive electrode plate according to claim 14, wherein:
the positive electrode current collector is any one of aluminum foil, carbon coated aluminum foil, and nickel mesh.

7. A preparation method for the positive electrode plate according to claim 1, comprising:
mixing the positive electrode active substance with an auxiliary agent to prepare slurry; and
applying the slurry evenly on the positive electrode current collector, drying and cold-pressing to obtain the positive electrode plate.

8. A lithium-ion secondary battery, comprising:
the positive electrode plate according to claim 1, as well as a negative electrode plate, an isolation film and an electrolyte, wherein the positive electrode plate, the isolation film, and the negative electrode plate are used to stack and wind successively to obtain an electrical core, and the electrolyte is used to inject into the dry electrical core to obtain the lithium-ion secondary battery.

9. The lithium-ion secondary battery according to claim 8, wherein:
the negative electrode plate comprises a negative electrode current collector and a negative electrode coating layer that is coated on the negative electrode current collector and contains a negative electrode active substance; wherein, the compaction density of the negative electrode coating layer is 1.35 g/cm³;
the surface density of the negative electrode coating layer is 0.0058 g/cm²; and the thickness of the negative electrode current collector is 8 μm.

10. The lithium-ion secondary battery according to claim 9, wherein:
the negative electrode active substance is any one of graphite, soft carbon, hard carbon, mesophase carbon microsphere, and silicon-based material.

11. The preparation method according to claim 7, wherein the positive electrode plate satisfies a formula: 0.1<a\hat{ }3*10*β/γ<0.125.

12. The preparation method according to claim 7, wherein the value range of the compaction density of the positive electrode coating layer is 2.6≤α≤3.2;
the value range of the surface density of the positive electrode coating layer is 0.0070≤β≤0.0085; and the value range of the thickness of the positive electrode current collector is 10≤γ≤25.

13. The preparation method according to claim 12, wherein the value range of the compaction density of the positive electrode coating layer is 2.75≤α≤3.1; the value range of the surface density of the positive electrode coating layer is 0.0070≤β≤0.0075; and the value range of the thickness of the positive electrode current collector is 16≤γ≤20.

14. The preparation method according to claim 7, wherein the positive electrode active substance is any one of lithium cobalt oxide, lithium nickel oxide, lithium manganese oxide, lithium nickel manganese oxide, lithium nickel cobalt manganese oxide, lithium nickel cobalt aluminum oxide, and olivine structure containing lithium phosphate.

15. The preparation method according to claim 7, wherein the positive electrode current collector is any one of aluminum foil, carbon coated aluminum foil, and nickel mesh.

16. The lithium-ion secondary battery according to claim 8, wherein the positive electrode plate satisfies a formula: 0.1<a\hat{ }3*10*β/γ<0.125.

17. The lithium-ion secondary battery according to claim 8, wherein the value range of the compaction density of the positive electrode coating layer is 2.6≤α≤3.2; the value range of the surface density of the positive electrode coating layer is 0.0070≤β≤0.0085; and the value range of the thickness of the positive electrode current collector is 10≤γ≤25.

18. The lithium-ion secondary battery according to claim 17, wherein the value range of the compaction density of the positive electrode coating layer is 2.75≤α≤3.1; the value range of the surface density of the positive electrode coating layer is 0.0070≤β≤0.0075; and the value range of the thickness of the positive electrode current collector is 16≤γ≤20.

19. The lithium-ion secondary battery according to claim 8, wherein the positive electrode active substance is any one of lithium cobalt oxide, lithium nickel oxide, lithium manganese oxide, lithium nickel manganese oxide, lithium nickel cobalt manganese oxide, lithium nickel cobalt aluminum oxide, and olivine structure containing lithium phosphate.

20. The lithium-ion secondary battery according to claim 8, wherein the positive electrode current collector is any one of aluminum foil, carbon coated aluminum foil, and nickel mesh.
